(19) United States
(12) Patent Application Publication
(10) Pub. No.: US 2024/0127679 A1
(43) Pub. Date: Apr. 18, 2024

(54) EMERGENCY BALLOON SIGNAL ASSEMBLY

(71) Applicant: Dale DeBoer, Hammond, IN (US)

(72) Inventor: Dale DeBoer, Hammond, IN (US)

(21) Appl. No.: 17/967,241

(22) Filed: Oct. 17, 2022

(51) Int. Cl. G08B 5/00; B64B 1/50; B64B 1/62; G08B 5/36

(52) U.S. Cl. CPC G08B 5/002; B64B 1/50; B64B 1/62; G08B 5/36

(57) ABSTRACT

An emergency balloon signal assembly for deploying an inflatable balloon from a pouch includes a pouch including an exterior wall enclosing an interior space. The pouch has opening extending therein for accessing the interior space. A strap has a pair of ends attached to the pouch to removably retain the pouch on an anchoring object. A balloon is removably positioned in the interior space and is inflatable and expandable when removed from the interior space. A valve is in fluid communication with the balloon. A gas canister contains a gas having a density at standard temperature pressure being less than the density of atmospheric air. The gas canister is fluidly attached to the valve to release the gas into the balloon. A tether has a first end attached to the balloon and a second end attached to the pouch.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to emergency signal devices and more particularly pertains to a new emergency signal device for deploying an inflatable balloon from a pouch to facilitate viewing of an emergency beacon.

### Description of Related Art Including Information Disclosed Under 37 CFR 1.97 and 1.98

The prior art relates to emergency signal devices including a variety of devices configured for deploying an inflatable balloon. Known prior art lacks an effective means for attaching such a beacon to an anchoring object.

### BRIEF SUMMARY OF THE INVENTION

An embodiment of the disclosure meets the needs presented above by generally comprising a pouch with an exterior wall enclosing an interior space. The pouch has opening extending therein for accessing the interior space. A strap has a pair of ends attached to the pouch to removably retain the pouch on an anchoring object. A balloon is removably positioned in the interior space in a deflated condition. The balloon is inflatable and expandable when removed from the interior space. A valve is in fluid communication with the balloon and is fluidly couplable to a gas canister containing a gas having a density at standard temperature pressure being less than the density of atmospheric air, i.e. a lighter than air gas. A tether has a first end coupled to the balloon and a second end attached to the pouch.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of an emergency balloon signal assembly according to an embodiment of the disclosure.

FIG. 2 is a front view of an embodiment of the disclosure.

FIG. 3 is a top isometric view of an embodiment of the disclosure.

FIG. 4 is a rear isometric view of an embodiment of the disclosure.

FIG. 5 is a detail view of an embodiment of the disclosure taken from FIG. 2 of magnified circle 5.

FIG. 6 is a detail view of an embodiment of the disclosure.

### DETAILED DESCRIPTION OF THE INVENTION

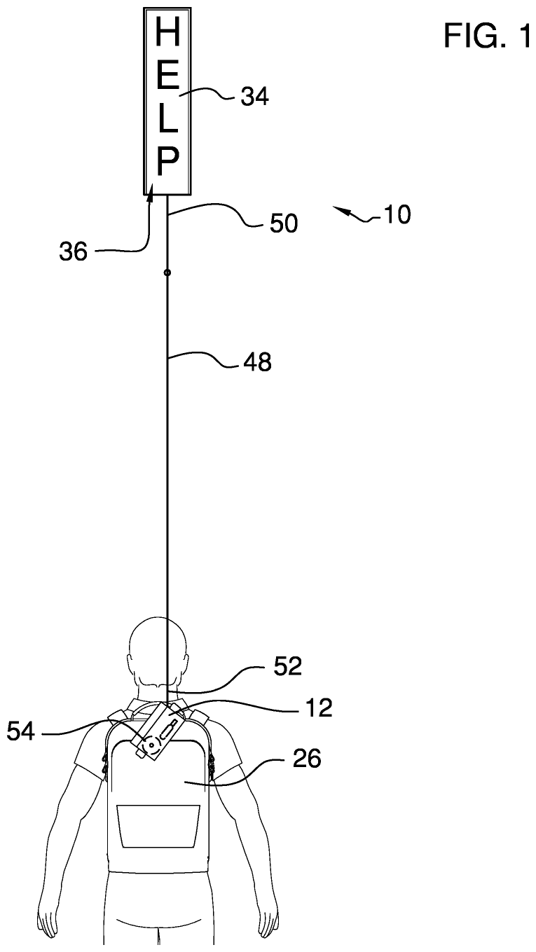

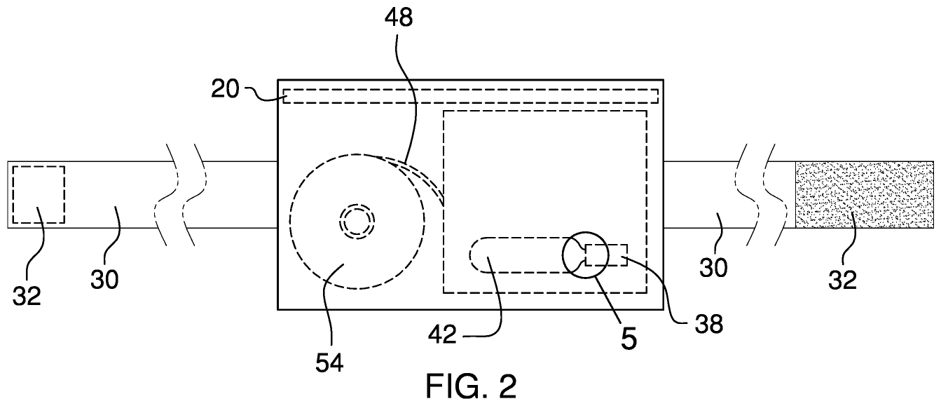

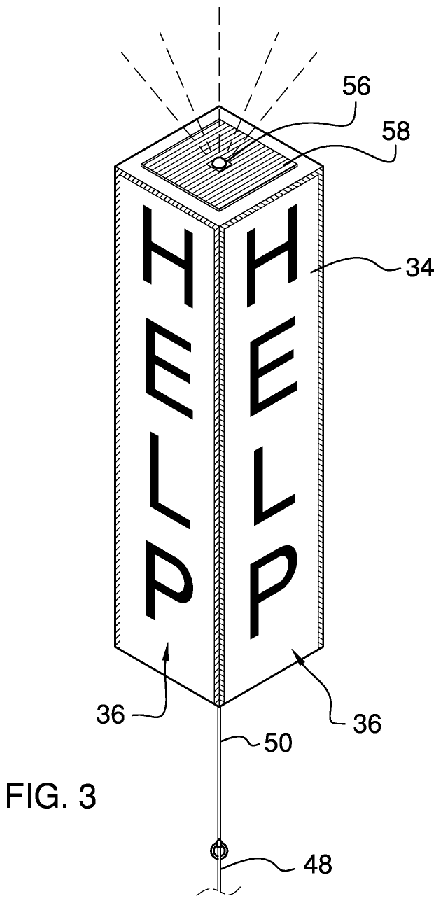

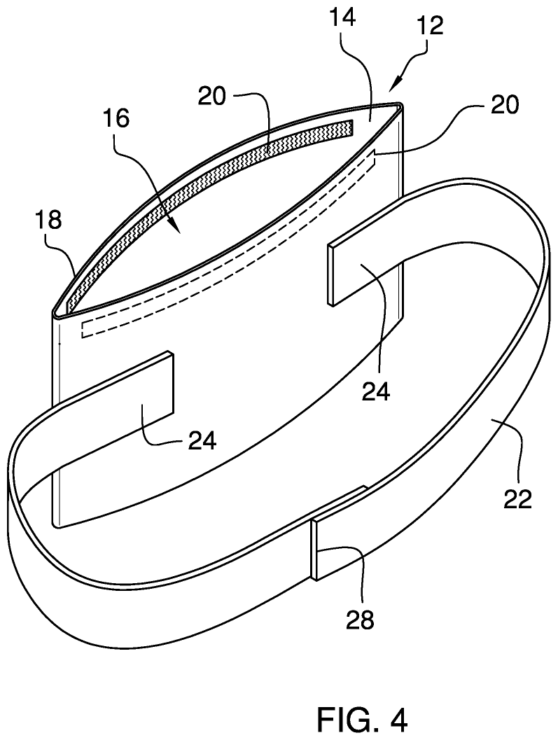

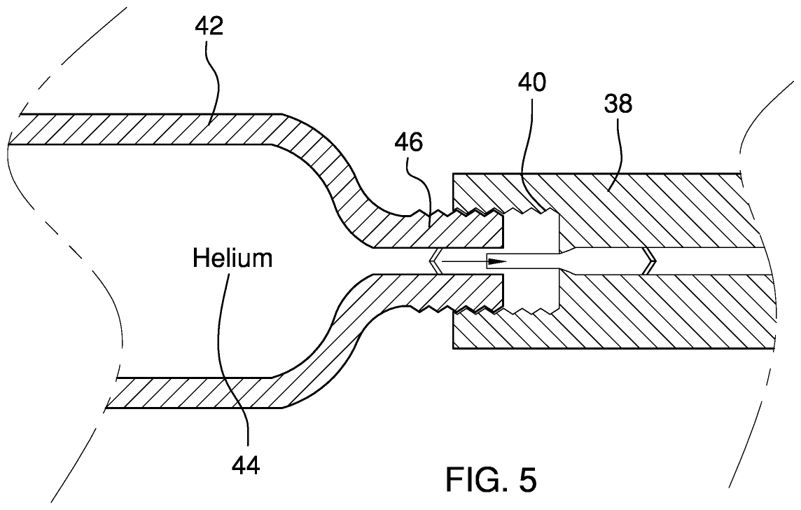

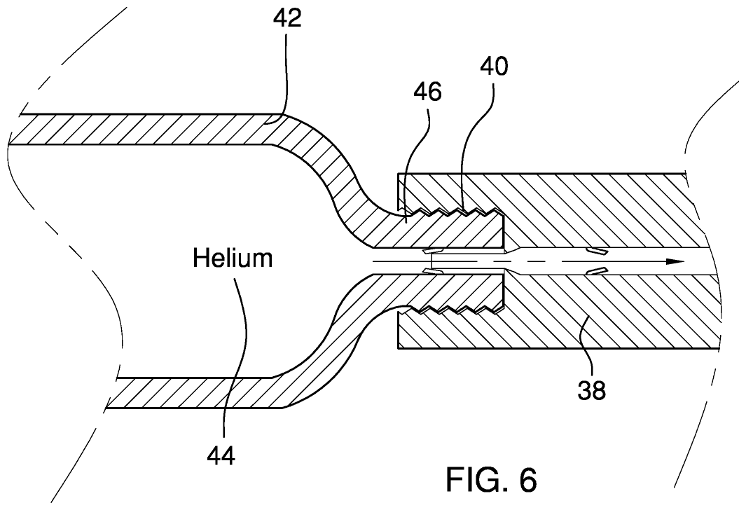

With reference now to the drawings, and in particular to FIGS. 1 through 6 thereof, a new emergency signal device embodying the principles and concepts of an embodiment of the disclosure and generally designated by the reference numeral 10 will be described.

As best illustrated in FIGS. 1 through 6, the emergency balloon signal assembly generally comprises a pouch 12 including an exterior wall 14 enclosing an interior space 16. The pouch 12 has an opening 18 extending therein for accessing the interior space 16. A fastening member 20 may be mounted on the pouch 12 for reversibly closing the opening 18. The fastening member 20 may comprise a hook and loop fastener.

A strap 22 having a pair of ends 24 attached to the pouch 12 may be configured to removably retain the pouch 12 on an anchoring object 26 such as a tree, a rock, a boat, a backpack, and/or a life jacket. The strap 22 has a break 28 therein to define a pair of sections 30. A connection member 32 releasably couples together the sections 30 to define a closed loop. The connection member 32 will likely comprise a hook and loop fastener, though snaps, buttons, zippers and the like may also be utilized.

A balloon 34 is removably positioned in the interior space 16 in a deflated condition. The balloon 34 is removed from the interior space 16 to so that it can expand and be inflated. The balloon 34 may have a vertically elongated shape when inflated and, as can be seen in the Figures, may have elongated rectangular box-like structure. The balloon 34 may further include indicia 36 such as “HELP” being for further signifying an emergency to nearby bystanders. The balloon 34 may be constructed of highly reflective material and/or colored a fluorescent or otherwise bright color to enhance the visibility of the balloon.

A valve 38 is in fluid communication with the balloon 34 and may include a threaded female receiver 40. The valve 38 may be a one way valve to allow air to flow into the balloon 12 and to restrict air from leaving the balloon 12. A gas canister 42 contains a gas 44 having a density at standard temperature pressure being less than the density of atmospheric air. Typically this gas 44 will be helium as is often used with inflatable balloons. The gas canister 42 fluidly couples to the valve 38 to release the gas 44 into the balloon 34. The gas canister 42 may have a threaded male coupler 46 being fluidly engageable with the threaded female receiver 40.

A tether 48 has a first end 50 being coupled to the balloon 34 and a second end 52 attached to the pouch 12. The tether 48 may have a length greater than 100 feet to allow the balloon 34 to ascend into the air when inflated, but will typically have a length no more than 300 feet. A spool 54, upon which the tether is wound, is positioned in the interior space 16 of the pouch 12 and is configured for unwinding the tether 48 as the balloon 34 ascends into the air. A light emitter 56 may be mounted on the balloon 34 to enhance visibility of the balloon 34 and a solar cell 58 may be electrically coupled to the light emitter 56 to supply electric power to the light emitter 56 or to a battery used a primary source of power. The light emitter 56 may comprise a light emitting diode which may emit a continuous light or which may intermittently flash. The light emitter may come with a power switch for turning the light emitter on or off, though the switch may be one which is activated upon inflation of the balloon.

In use, the balloon 34 is removed from the interior space 16 of the pouch 12. The gas canister 42 then fluidly couples to the valve 38 to inflate the balloon 34. The strap 22 of the pouch 12 may be secured to the anchoring object 26 such as a backpack worn by a person, to the person themselves, or to any other heavy or anchored object to prevent the balloon 34 from floating away from the area in which an emergency response is needed. The balloon 34, being highly visible, will draw attention from nearby persons.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An emergency balloon signal assembly comprising:
a pouch comprising an exterior wall enclosing an interior space, said pouch having an opening extending therein for accessing said interior space;
a strap having a pair of ends being attached to said pouch, said strap being configured to removably retaining said pouch on an anchoring object;
a balloon being removably positioned in said interior space in a deflated condition, said balloon being inflatable and expandable when removed from said interior space;
a valve being in fluid communication with said balloon;
a gas canister containing a gas having a density at standard temperature pressure being less than the density of atmospheric air, said gas canister being fluidly couplable to said valve to release the gas into the balloon; and
a tether having a first end being coupled to said balloon and a second end attached to said pouch.

2. The emergency balloon signal assembly of claim 1, further including a fastening member being mounted on said pouch and being configured for reversibly closing said opening said fastening member comprising a hook and loop fastener.

3. The emergency balloon signal assembly of claim 1, wherein said strap has a break therein to define a pair of sections, a connection member releasably coupling together said sections to define a closed loop, said connection member comprising a hook and loop fastener.

4. The emergency balloon signal assembly of claim 1, wherein said balloon has a vertically elongated shape when inflated.

5. The emergency balloon signal assembly of claim 1, wherein said valve includes a threaded female receiver, said valve being a one way valve to allow air to flow into said balloon and to restrict air from leaving said balloon.

6. The emergency balloon signal assembly of claim 5, wherein said gas canister has a threaded male coupler being fluidly engageable with said threaded female receiver.

7. The emergency balloon signal assembly of claim 1, wherein said gas comprises helium.

8. The emergency balloon signal assembly of claim 1, wherein said tether has a length greater than 100 feet.

9. The emergency balloon signal assembly of claim 8, further including a spool being wound with said tether.

10. The emergency balloon signal assembly of claim 1, further including a light emitter being mounted on said balloon.

11. The emergency balloon signal assembly of claim 10, further including a solar cell being electrically coupled to said light emitter and supplying electric power to said light emitter.

12. An emergency balloon signal assembly comprising:
a pouch comprising an exterior wall enclosing an interior space, said pouch having an opening extending therein for accessing said interior space, a fastening member being mounted on said pouch and being configured for reversibly closing said opening said fastening member comprising a hook and loop fastener;
a strap having a pair of ends being attached to said pouch, said strap being configured to removably retaining said pouch on an anchoring object, said strap having a break therein to define a pair of sections, a connection member releasably coupling together said sections to define a closed loop, said connection member comprising a hook and loop fastener;
a balloon being removably positioned in said interior space in a deflated condition, said balloon being inflatable and expandable when removed from said interior space, said balloon having a vertically elongated shape when inflated;
a valve being in fluid communication with said balloon, said valve including a threaded female receiver, said valve being a one way valve to allow air to flow into said balloon and to restrict air from leaving said balloon;
a gas canister containing a gas having a density at standard temperature pressure being less than the density of atmospheric air, said gas canister being fluidly couplable to said valve to release the gas into the balloon, said gas canister having a threaded male coupler being fluidly engageable with said threaded female receiver, said gas comprising helium
a tether having a first end being coupled to said balloon and a second end attached to said pouch, said tether having a length greater than 100 feet;
a spool being wound with said tether;
a light emitter being mounted on said balloon; and
a solar cell being electrically coupled to said light emitter and supplying electric power to said light emitter.
